(19) United States
(12) Patent Application Publication
(10) Pub. No.: US 2003/0074763 A1
(43) Pub. Date: Apr. 24, 2003

(54) Wiper device for cleaning the glass panes of vehicles, especially automobiles

(76) Inventors: Bruno Egner-Walter, Heilbronn (DE); Jean-Louis Roumeqoux, Paris (FR)

Correspondence Address: Andrew R Basile, Young & Basile, Suite 624, 3001 West Big Beaver Road, Troy, MI, 48084, US

(21) Appl. No.: 10/169,384

(22) PCT Filed: Jan. 5, 2001
(86) PCT No.: PCT/EP01/00094

(30) Foreign Application Priority Data
Jan. 7, 2000 (DE) 10000382.6
Jan. 7, 2000 (DE) 10000389.3
Mar. 24, 2000 (DE) 10014803.4

(51) Int. Cl. B60S 1/38; B60S 1/40; B60S 1/32

(52) U.S. Cl. 15/250.201; 15/250.32; 15/250.43; 15/250.351

(57) ABSTRACT

In the case of a wiper device for cleaning glass panes on vehicles, in particular automobiles, the wiper strip (2), which consists of an elastomeric material, is furnished with a molded spoiler (15) on a wiper strip upper side (14). The molded spoiler extends only in a wiper arm area (1″) which lies between one end of the wiper blade (1) and means of attachment (11) to attach the wiper blade (1) to an arm of a windshield wiper.

The invention relates to a wiper device in accordance with the preamble of claim 1.

Wiper devices for cleaning glass panes on automobiles are known in a wide variety of embodiments. Especially known are what are called flat wiper blades, which consist basically of a wiper strip made of elastomeric material and supports strips or splines engaging lateral longitudinal grooves in the wiper strip, which project with part of their width beyond opposing longitudinal sides of the wiper strip, or a profiled section of this wiper strip, and are attached to the wiper strip at both its ends and to each other by means of end caps or connecting pieces to the wiper strip (DE-A-197 39 256).

In the case of flat wiper blades of this type it is further known to shape the wiper strip on the upper side facing away from the lip and thus from the glass surface to be cleaned as a spoiler, that is, with an oblique surface whose plane includes an angle of less than 90 with the plane of the glass surface when it is in use, or to configure it with a corresponding concave curved incline (DE-A 197 34 843). The high weight of these known wiper strips is in itself a disadvantage. Furthermore, as a result of the necessary positioning of the wiper arm forming part of the wiper device above the spoiler furnished on the wiper blade, the height of the wiper device is still too high and the accommodation of wiper arm and wiper blade is poorly designed .

It is the object of the invention to demonstrate a wiper device which avoids the disadvantages of the aforementioned known wiper devices and, while having reduced weight and further reduced overall height, also improves the accommodation of the wiper arm to the wiper blade.

To accomplish this object a wiper device is configured in accordance with claim 1. As a result of the spoiler molded with the upper side of the wiper strip extending in only one area between the means for attaching the wiper blade to the wiper arm and one end of the wiper blade, it extends to some degree only over about half the length of the wiper strip. This markedly reduces the weight of the wiper strip. Furthermore, in the other area in which there is no molded spoiler on the upper side of the wiper strip, the wiper blade can be brought closer to a wiper arm located over this area, whereby the overall height is reduced. In addition, the possibilities for accommodating the wiper blade to the wiper arm are improved.

A further development of the invention provides for the spoiler to have a changing height in the longitudinal direction of the wiper blade by which the spoiler, or an upper spoiler edge, projects beyond the plane of an underside of the wiper strip. The weight of the wiper strip can thereby be reduced by an additional amount. In an application of a still further development of the invention, whereby the height of the spoiler decreases towards the one end of the wiper blade, or the wiper strip, an improvement can be achieved in the wiper device in the sense of attractive styling, in addition to a technical improvement.

Another further development of the invention provides for the spoiler to have a constant, or basically constant, height. This has the advantage that the spoiler has a greater effective aerodynamic surface, and the wiper strip can be produced less expensively as an extruded part.

Another further development of the invention provides for a wiper device in which the molded spoiler on the wiper strip forms a first spoiler surface and for the wiper arm, at least over an intermediate length, to have an external cross section having at least a second spoiler surface. This inventive embodiment, which requires only a small number of separate parts while having extremely low height, allows manufacture to be particularly inexpensive by reducing the cost of parts and assembly. The small number of parts has a particularly beneficial effect on the visual design of wiper blade and wiper arm, specifically because there are only a few edges and transitions.

In the case of the inventive embodiment it is possible to shape the wiper strip (wiper rubber) and the wiper arm in such a way that the shape of the upper side of the wiper strip, and specifically the spoiler surface as well, continue in their shape the spoiler surface of the wiper arm. In a preferred embodiment the wiper arm is connected at its one end in such a way with the wiper blade that it overlaps the wiper blade over part of its length. As a result, it is also possible to make the design of the junction between wiper blade and wiper arm particularly simple.

Other further developments of the inventive wiper device are the subject of subclaims 8 to 15 and will be explained in greater detail in the embodiments.

The inventive wiper device will now be explained in greater detail in what follows by way of using embodiments with reference to the drawings.

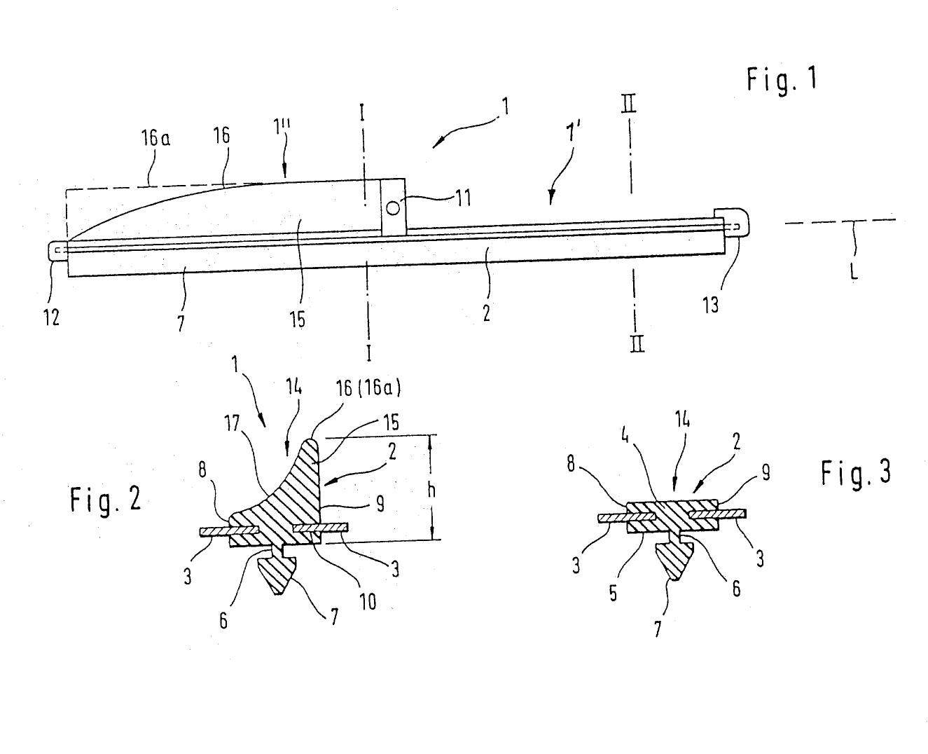

FIG. 1 shows in a simplified representation and in a side view a flat wiper blade having a spoiler on one side;

FIG. 2 shows a section along line I-I from FIG. 1 in the area of the spoiler;

FIG. 3 shows a section along line II-II from FIG. 1 away from the spoiler;

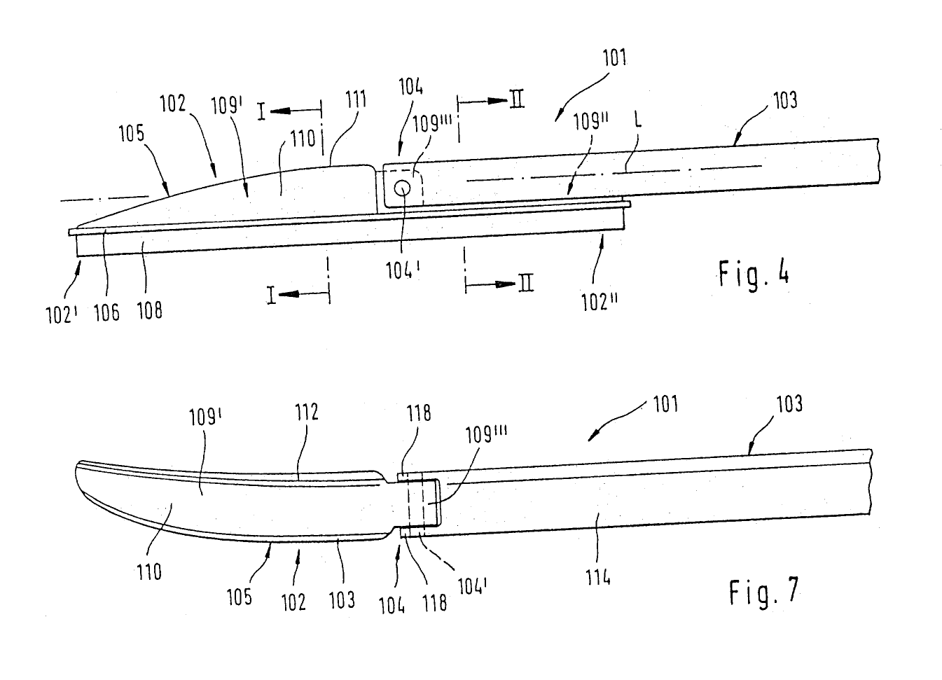

FIG. 4 shows in a highly simplified representation and in a side view a wiper blade-wiper arm array of a windshield wiper in accordance with the invention;

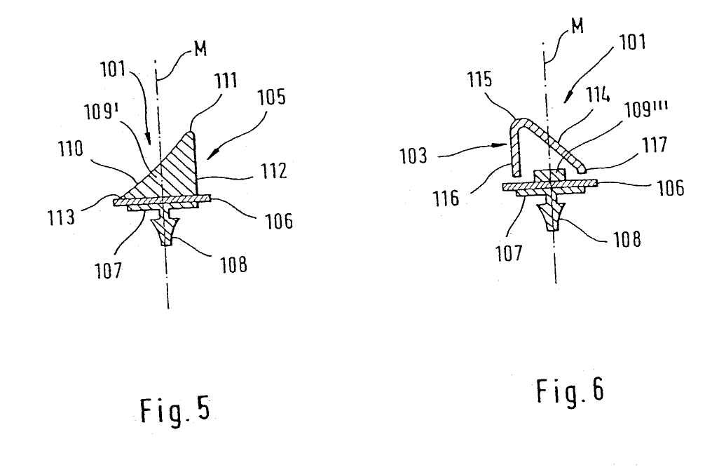

FIG. 5 shows a section along line I-I from FIG. 4;

FIG. 6 shows a section along line II-II from FIG. 4;

FIG. 7 shows a plan view of the array from FIG. 4.

FIGS. 1 to 3 show as a possible embodiment of the invention a wiper blade identified overall as 1 for use in a wiper device. The wiper blade is configured over an intermediates length as a “flat wiper blade” and consists in a known way of a wiper strip 2, which is manufactured as a profile from an elastomeric material, and of two flat strip-shaped supports or splines holding the wiper strip 2 between them, which are made from a flexible material, preferably of spring steel and which, like wiper strip 2, extend over the entire length of wiper blade 1.

The profile of wiper strip 2 forms a profiled section 4 with an underside 5 on which, by means of a molded hinge 6 roughly in the middle of the underside 5, the similarly molded lip 7 is provided, with which the operational wiper blade lies in contact with the glass pane to be cleaned. Hinge 6 and lip 7 extend over the entire length of wiper strip 2. On two longitudinal sides 8 and 9 lying in planes perpendicular to the plane of the underside 5 in the embodiment shown, wiper strip 2 is furnished in each instance with a longitudinal groove 10 which is open on these longitudinal sides as well as at both ends of wiper strip 2 and which lie parallel to the underside 5 in a common plane. Part of the width of a spline 3 is accommodated in each longitudinal groove 10. The other part of the width of each support strip 3 projects out of the longitudinal groove 10 beyond the corresponding longitudinal side 8 or 9, in the embodiment shown specifically about half of its width.

In the center of wiper blade 1, attached to the splines 3 is an adapter, by means of which wiper blade 1 is connected to the wiper arm (not shown) of the windshield wiper. Furthermore, end caps 12 and 13 are furnished at both ends of the wiper blade 1 which connect the ends of the splines to each other and to the wiper strip 2.

As FIG. 3 shows, the profile of wiper strip 2 in the intermediate area 1′ of wiper blade 1 between adapter 11 and the one end of the wiper blade having the end cap 13 is basically formed by the flat profiled section 4, which is rectangular in the embodiment shown, where the larger cross-sectional sides of this profiled section are formed by the underside 5 and the opposite upper side of the wiper strip 14, and the two short cross-sectional sides are formed by the longitudinal sides 8 and 9 there.

As FIG. 2 shows, the cross-section of wiper strip 2 in intermediate section 1″ between adapter 11 and the other end of the profiled section 4 having end cap 12 is formed by profiled section 4 and an integral spoiler 15 which is molded onto the upper side of the wiper strip directed away from underside 5. The spoiler 15 is furthermore so configured that the height h of this spoiler, that is, the distance of spoiler edge 16 extending in the longitudinal direction L of the wiper blade from underside 5, is greatest at adapter 11, specifically equal to the height of adapter 11. The height h decreases toward the end of wiper strip 2 having the end cap 12.

However, the possibility always exists, as suggested in FIG. 1 by the broken line 16a, of configuring the spoiler 15 with a constant height h over its entire length.

The cross-section of spoiler 15 is defined by the fact that one longitudinal side 9 has a greater height in the area of this spoiler, at which height this longitudinal side extends as far as edge 16 or 16a respectively, where spoiler surface 17 drops from edge 16 or 16a respectively to the height of longitudinal side 8 and is concavely curved about an axis running parallel to the longitudinal elongation L of wiper strip 2.

In the embodiment shown spoiler 15 extends right up to adapter 11, which results in an attractive exterior appearance, particularly when spoiler 11 at adapter 15 has the same height as this adapter 11. Basically, embodiments are also conceivable in which spoiler 15 ends at some distance from adapter 11. In the embodiment shown spoiler 15 is configured at its end adjacent to adapter 11 such that planar contact of the spoiler with adapter 11 is ensured.

The wiper blade-wiper arm array identified generally in FIGS. 4 to 7 with 101 consists essentially of a wiper blade 102 and a wiper arm 103. In a junction area 104 wiper blade 102 is connected approximately in the center of the wiper blade to one end of wiper arm 103, specifically rotatable through a limited pivot angle about the axis of a connecting or swivel pin 104′ which is disposed with this axis perpendicular to the longitudinal elongation of the wiper blade 102 and of the wiper arm 103 as well as perpendicular to a center plane M which includes this longitudinal elongation or longitudinal axis. Wiper blade 102 and wiper arm 103 are furthermore so disposed that wiper arm 103 overlaps wiper blade 102 over an intermediate length, and in the plan view of wiper blade-wiper arm array 101 (FIG. 7) is located over wiper blade 102.

The wiper blade 102 consists in a known way of a wiper strip 105 which is made from an elastomeric material, for example by injection molding or pressing, and is connected to a support strip or spline 106 extending over the entire length of wiper strip 105, for example by molding onto spline 106 or in another suitable way. Spline 106 is made from a flexible flat material, for example by stamping from a flexible steel sheet.

Wiper strip 105 is profiled over its entire length such that a first profiled section 107 projects beyond the underside of the spline 106 disposed with its upper sides perpendicular to the center plane M and there forms a bridge with a molded-in lip 108, with which the wiper strip 102 lies in contact with the vehicle glass to be cleaned when in use. The profiled section 107 and the lip 108 are configured symmetrically to the center axis M in the embodiment shown.

Over an intermediate length wiper strip 105 forms a upper profiled section 109′, which is located above the spline 106 and extends from the open end, that is, from the end of wiper strip 105 not overlapped by wiper arm 103, as far as the area of junction 104.

As FIG. 5 in particular shows, profiled section 109′ is shaped as a spoiler in a way that this profiled section forms a spoiler surface 110 on the upper side of wiper strip 105 running obliquely to the plane of the top surfaces of spline 106, starting from an upper spoiler edge 111 on one longitudinal side of wiper strip 105 on the approximate level of the top side of the spline 106 to the other opposite longitudinal side 113 of wiper strip 105.

As is also shown in particular in FIG. 4, the height (distance from the plane of spline 106) of the spoiler edge 111 changes over the length of wiper blade 102, specifically such that this height increases from the open end 102′ of the wiper blade 102 to the center of this wiper blade, or to the area of junction 104 respectively. As FIG. 5 furthermore shows, the profiled section 109′ is of a width that is approximately the same as or marginally smaller than the width of the spline 106.

From the area of the junction 104 as far as the other end 102″ of wiper blade 102, that is, in the area in which wiper arm 103 overlaps wiper blade 102, wiper strip 105 has an upper profiled section 109″ with a strip-like configuration having a constant or basically constant height and width, however having height and width which are considerably smaller than the corresponding height and width of profiled section 109′.

As FIG. 6 shows particularly clearly, wiper arm 103 is manufactured as a profile open downwardly, that is, toward wiper blade 102, and, by way of example, by being shaped from a metal or steel sheet such that the outer contour of wiper arm 103 is the same as, or nearly the same as, the outer contour of wiper strip 105 or its profiled section 109′ in the junction area 104. This means that wiper arm 103 also forms a spoiler surface 114 which, starting from one spoiler edge 115 on one longitudinal side 116 of wiper arm 103, runs obliquely downward, meaning in the direction of wiper blade 102 and to the other longitudinal side 117.

At the area of junction 104 wiper arm 103 is configured with two parallel clips 118 between which an intermediate section 109′″ is positioned and in which pivot pin 104′ rides at both ends.

The array is furthermore disposed in such a way that spoiler surface 114 essentially forms the continuation of spoiler surface 110, longitudinal side 116 the continuation of longitudinal side 112, longitudinal side 117 the continuation of longitudinal side 113 and spoiler edge 115 the continuation of spoiler edge 111. When wiper blade-wiper arm array 101 is in use, longitudinal sides 112 and 117 are the forward longitudinal sides in the direction of vehicle travel, so that spoiler surfaces 110 and 114 each face forward.

While, in the case of the embodiment shown, wiper arm 103, particularly in plan view (FIG. 7) is configured straight or essentially straight, over the intermediate length not overlapped by wiper arm 103 between end 102′ and the area of the junction 104, wiper blade 102 exhibits a slight curvature about axes parallel to the center axis M and perpendicular to longitudinal axis L, such that wiper blade 102 has a convex curvature on the front side, that is on longitudinal side 113, and a concave curvature on the back side, that is on longitudinal side 112.

Departing from the embodiment described in FIGS. 4 and 7, it is also possible, for example, to endow wiper blade 102 between the area of the junction 104 and end 102″ with a curvature, where in this case wiper arm 103 is also correspondingly curved, at least in an intermediate area.

The invention was described in what preceded by way of using embodiments. It is understood that numerous modifications and alterations are possible without departing from the fundamental inventive idea of the invention.

List of Reference Numerals

| | |
|---|---|
| 1 | Wiper blade |
| 1′, 1″ | Wiper blade intermediate area |
| 2 | Wiper strip |
| 3 | Support or spline |
| 4 | Profiled section |
| 5 | Underside of profiled section |
| 6 | Hinge |
| 7 | Wiper lip |
| 8, 9 | Longitudinal side |
| 10 | Longitudinal groove |
| 11 | Adapter |
| 12, 13 | End cap |
| 14 | Upper side |
| 15 | Spoiler |
| 16, 16a | Edge of spoiler |
| 17 | Inclined spoiler surface |
| 101 | Wiper blade-wiper arm array |
| 102 | Wiper blade |
| 102′, 102″ | End of wiper blade |
| 103 | Wiper arm |
| 104 | Area of junction |
| 104′ | Pivot pin |
| 105 | Wiper strip |
| 106 | Spline |
| 107 | Profiled section |
| 108 | Wiper lip |
| 109′, 109″ | Profiled section |
| 109′″ | Intermediate section |
| 110 | Spoiler surface |
| 111 | Spoiler edge |
| 112, 113 | Longitudinal side |
| 114 | Spoiler surface |
| 115 | Spoiler edge |
| 116, 117 | Longitudinal side |
| 118 | Clip |
| L | Longitudinal axis |
| M | Center plane |

What is claimed is:

1. Wiper device for cleaning glass surfaces in vehicles, specifically automobiles, having a wiper blade-wiper arm array with a wiper blade (1, 102) with an elongate wiper strip (2, 105) consisting of an elastomeric material which, with a wiper strip underside or at least with a wiper lip (7, 108) furnished on the wiper strip underside, can be placed in contact with the specific glass surface and on whose upper side a spoiler (15, 110) is formed and is provided on both of its longitudinal sides (8, 9, 112, 113) with opposingly located longitudinal grooves (10) which are each engaged by preferably flexible support strips (3, 106) extending in the longitudinal direction (L) of the wiper strip (2, 105), as well as with means (11) to attach the wiper blade (1, 102) to a wiper arm (103) which is part of the wiper device, and with a wiper arm (103) which is connectable or is connected to a wiper blade (1, 102) in an area formed for the junction (104) between the ends of the wiper blade (1, 102), where one wiper blade end (102″) is proximate to the wiper arm and the other wiper blade end (102′) is distal to the wiper arm (103), characterized in that the molded spoiler (16, 110) extends only in an area (1″, 109′) of the wiper blade lying between the attaching means (11) and one end of the wiper blade (1, 102).

2. Wiper device in accordance with claim 1, wherein the spoiler (15, 110) has a changing height (h) in the longitudinal direction (L) of the wiper blade by which the spoiler (15, 110) or an edge of spoiler (16, 16a, 111) projects beyond the plane of an underside of the wiper strip (2, 105).

3. Wiper device in accordance with claim 2, wherein the height of the spoiler (15, 110) decreases toward the one end (102′) of the wiper blade (1, 102) or the wiper strip (2, 105).

4. Wiper device in accordance with claim 1, wherein the spoiler (15, 110) possesses a constant or essentially constant height (h).

5. Wiper device in accordance with one of the preceding claims, where the spoiler molded on the wiper strip forms a first spoiler surface (15, 110), wherein the wiper arm (103) has an outer cross-section having at least one second spoiler surface (114) at least over an intermediate length.

6. Wiper device in accordance with claim 5, wherein the second spoiler surface (114) forms the continuation of the first spoiler surface (15, 110).

7. Wiper device in accordance with claim 5 or 6, wherein the wiper arm (103) overlaps the wiper blade (1, 102) over an intermediate length between the one end of the wiper blade (102′) and the area of the junction (11, 104).

8. Wiper device in accordance with one of the preceding claims 5 to 7, wherein the first surface of the spoiler (16, 110) extends over the entire, or almost the entire intermediate length of the wiper blade (1, 102) between the area of the junction (11, 104)and the other end of the wiper blade (102′).

9. Wiper device in accordance with one of the preceding claims 5 to 8, wherein the first surface of the spoiler (15, 110) emanates from a first edge of the spoiler (16, 111) and wherein the first edge of the spoiler (16, 111) has a changing height in the longitudinal direction of the wiper blade (1, 102).

10. Wiper device in accordance with claim 9, wherein the height of the first edge of the spoiler (16, 111) rises from the other end of the wiper blade (102′) toward the area of the junction (11, 104).

11. Wiper device in accordance with one of the preceding claims 5 to 10, wherein the first edge of the spoiler (16, 16a, 111) and the second edge of the spoiler (115) each has the same height at the area of the junction (11, 104).

12. Wiper device in accordance with one of the preceding claims 5 to 11, wherein the wiper arm (103) engages a profiled section (109′) of the wiper strip 105 in the area of the junction (104)from above, preferably straddles it from above.

13. Wiper device in accordance with one of the preceding claims 5 to 12, wherein the wiper arm (103) is formed from a profile which is open toward the underside of the wiper blade (1, 102) or of the wiper strip (2, 105) respectively.

14. Wiper device in accordance with one of the preceding claims 5 to 13, wherein the wiper strip (2, 105) over an intermediate length (1″) between the one end of the wiper blade (102″) and the area of the junction (104) has a lower height and/or width than over the intermediate length (1′) between the area of the junction (104) and the other end of the wiper blade (102′).

15. Wiper device in accordance with one of the preceding claims 5 to 14, wherein at least the wiper blade (102) over an intermediate length, preferably at least over a part of the length between the area of the junction (104) and the other end of the wiper blade (102′) on a longitudinal side (112) proximal to the edge of the spoiler (111), has a concave curvature and/or on an additional longitudinal side (113) opposite to this longitudinal side has a convex curvature.
